(19) United States
(12) Patent Application Publication
(10) Pub. No.: US 2011/0318004 A1
(43) Pub. Date: Dec. 29, 2011

(54) TRANSMISSION AND ROUTING OF OPTICAL SIGNALS

(75) Inventor: Gianmarco Bruno, Genova (IT)

(73) Assignee: Telefonaktiebolaget L M Ericsson (publ), Stockholm (SE)

(21) Appl. No.: 13/141,828

(22) PCT Filed: Feb. 11, 2009
(86) PCT No.: PCT/EP2009/051585

§ 371 Date: Sep. 12, 2011

(30) Foreign Application Priority Data
Dec. 23, 2008 (EP) 08172852.9

(51) Int. Cl. H04J 14/00

(52) U.S. Cl. 398/45

(57) ABSTRACT

Methods and apparatus for routing and transmission of inverse multiplexed signals over optical communications networks are described. A method for routing includes determining a plurality of paths for transmission of a plurality of inverse-multiplexed optical signals from a source node to a destination node of an optical network. Each path is for transmission of at least one of the inverse-multiplexed optical signals. A latency difference between a fastest one of said paths and a slowest one of said paths is less than a predetermined time period.

### TECHNICAL FIELD

The present invention relates in general to optical communication networks and in particular to methods and apparatus for routing and/or transmission of inverse multiplexed signals over optical communications networks. Embodiments of the present invention are particularly suitable for routing and transmission of such signals over optical mesh networks.

### BACKGROUND

Wavelength division multiplexing is the transmission of several different signals via a single optical transmission medium (e.g. fibre), by sending each signal (“channel”) at a different optical frequency or wavelength. A multiplexer is used to combine the different channels together for transmission, and a demultiplexer is used to separate the channels following transmission. WDM optical transmission systems are typically composed of a number of spans of optical fibre linking together the network nodes.

Early WDM networks used simple, fixed optical filters to route the optical signals point to point, between two predetermined network nodes. Such networks were therefore essentially “static” i.e. the channel configuration (number of channels being transmitted, and the routing of the channels through nodes of the network) did not change, except during fault conditions or due to human intervention to upgrade or alter the network configuration.

More recent WDM networks can include reconfigurable optical network nodes, which allow remote reconfiguration of the channels, raster provisioning of new channels and improved network resilience. Such reconfigurable optical network nodes commonly employ integrated optical devices, such as ROADM (Reconfigurable Optical Add-Drop Multiplexer) or WSS (Wavelength-Selective Switch) devices or similar, in order to control and route the optical signals.

Telecommunications appears to continuously face a need for ever greater available bandwidth. Currently, this need is driven by new services like router interconnection, video on demand and the growing Internet traffic. The traditional solution is to exploit the huge bandwidth of the optical fibre by using WDM and variants thereof, and also by increasing the signalling rate of each optical channel. The signalling rate has been increased in time with a factor of 4 (ITU-T SDH/SONET) or 10 (IEEE Ethernet) and novel solutions are being continuously developed to face the related transmission issues, like multi-level modulation formats, techniques for signal processing in the electrical and/or optical domain and advanced error-correction algorithms.

In order to carry a high-bit rate signal for which the above mentioned solutions are too expensive or impractical, one possible alternative solution is “inverse multiplexing”. Inverse multiplexing allows a single data stream to be broken into multiple lower data rate communications streams. At lower data rates, optical propagation impairments that depend on bit-rate (like chromatic dispersion CD, polarization mode dispersion PMD, filtering penalties) can be better managed and more cost-effective hardware can be utilised. By contrast, an efficient demultiplexing and multiplexing scheme is required in order to reconstruct the original payload and electronic buffering is required to manage the diverse latencies experienced by the low-rate channels.

In the field of optical networks, the most natural application of inverse multiplexing is to leverage an optical infrastructure designed for, say 10 Gb/s signals, to carry higher data rate signals like 40 Gb/s or 100 Gb/s. The client signal is broken into several low-rate signals that are carried through the network without any hardware upgrade at the optical layer (e.g. amplifiers, dispersion compensating modules DCMs, filters).

An example of 1-to-4 inverse-multiplexing technique is the transport of 40 Gb/s signals by means of 4×10 Gb/s wavelengths as addressed by the X40 industry collaboration Multi Source Agreement group (e.g. see the presentation by the X40 MSA Group “40 b/s Multi-rate Pluggable Optical Transceivers”, http://www.x40msagroup.com/X40-MSA-Presentation.pdf), which aims to leverage the availability of low-cost optics.

The transport of 100 Gb/s signals over long-haul networks has been already demonstrated via 10×10 Gb/s inverse multiplexing. Other implementations under discussion are the 5×20 Gb/s and 4×25 Gb/s schemes for transport of 100 Gb/s signals.

In order to minimize the latency due to the propagation in fibre, such schemes require that each channel is sent along the same optical fibre path.

The significant issue for such inverse multiplexing schemes is the delay compensation. The absolute latency time tᵢ experienced by a signal allocated at wavelength λᵢ traveling in a single-mode fiber of length l is about:

$${t}_{i} = \frac{l}{{c}_{0}} n ( {λ}_{i} ) \qquad Equation 1$$

Where c₀ is the light velocity in vacuum and n is the refractive index at wavelength λᵢ.

Consider two signals of respect wavelengths λ₁,λ₂, each travelling along a separate path (of respective lengths l₁ and l₂), with the paths differing in length by Δl. The differential latency time Δt (the time difference between the signal sent along the shortest path and the signal sent along the longest path) is:

$$Δ t = \frac{{l}_{2}}{{c}_{0}} n ( {λ}_{2} ) - \frac{{l}_{1}}{{c}_{0}} n ( {λ}_{1} ) ≅ \frac{Δ l}{{c}_{0}} n \qquad Equation 2$$

By way of contrast, the differential latency time Δt′ of a set of signals traveling through the same physical path is:

Δt′=l·D·Δλ Equation 3

Where D is the chromatic dispersion, l is the link length and Δλ is the wavelength separation between the widest spaced channels.

It is worth noting that Δt>>Δt′ by several orders of magnitude. For example, in a 1000 km long path over G.652 fibre (fibre made to the specifications of the ITU-T recommendation G.652), the maximum differential latency time is experienced by channels at the extremes of the C-band and is about 530 ns. On the other hand, two channels that are sent over two paths whose length difference is 1000 km, experience a differential latency of about 200 ms i.e. several orders of magnitude greater.

Thus, it is known that it is necessary to transmit such inverse-multiplexed signals along the same optical fibre path. Otherwise, substantial buffers would have to be provided, to allow buffering of the channels sent along different paths, to allow the channels to be appropriately re-combined to form the original high-bit rate signal.

Inverse multiplexing may also allow an improvement in redundancy at the WDM layer by transmitting a protection channel. For example a 40 Gb/s signal with one protected wavelength can be implemented as 5×10 Gb/s, with four of the channels used to carry the signal and one channel used as a protection channel. Unfortunately, the protection is limited to card faults because any line fault affects all channels at the same time.

### SUMMARY

It is an aim of preferred embodiments of the invention to provide a method and apparatus for routing and/or transmission of inverse multiplexed signals over optical communications networks that allow a relatively efficient use of the available bandwidth between source and destination nodes.

In a first aspect, the present invention provides method for routing inverse-multiplexed optical signals over a network. The method comprises determining a plurality of paths for transmission of a plurality of inverse-multiplexed optical signals from a source node to a destination node of an optical network. Each path is for transmission of at least one of said inverse-multiplexed optical signals. A latency difference between a fastest one of said paths and a slowest one of said paths is less than a predetermined time period.

The present inventor has appreciated that it is the difference in path latency that is most significant, rather than the absolute latency of each path. By ensuring that the difference in latency is kept within a predetermined, (acceptable), limit, routing of inverse-multiplexed signals along diverse paths becomes feasible. Thus, more efficient use can be made of the available bandwidth between source and destination nodes, rather than all traffic having to be transmitted along the same route. Further, if a protection channel is transmitted, due to the different routes that may be taken by the inverse-multiplexed signals, any line fault need not affect all channels at the same time i.e. inverse-multiplexed signals need not be limited to card fault protection.

Said latency difference may be less than a latency difference between said plurality of inverse-multiplexed optical signals that can be compensated for at the destination node.

The determined paths may be selected from a set of possible paths in dependence upon latency difference between the possible paths.

The set may comprise at least one path comprising a link from a first node to a second node and a link from said second node back to the first node.

The determined paths may be selected from a set of possible paths in dependence upon a transmission quality of each possible path.

The determined paths may be selected from a set of possible paths in dependence upon a loading of each possible path.

The determined paths may be selected from a set of possible paths in dependence upon a number of links that each possible path shares with other possible paths.

Each determined path may comprise different links.

The network may be a mesh network.

Said inverse-multiplexed optical signals may be derived from the inverse multiplexing of a single data stream.

The method may comprise transmitting at least one control signal to configure nodes of the network for transmission of said inverse-multiplexed optical signals along the determined paths.

The method may comprise transmitting said inverse-multiplexed optical signals from said source node towards said destination node along the determined paths.

In a second aspect, the present invention provides a method of transmitting optical signals over a network. The method comprises inverse multiplexing a data stream to a plurality of inverse multiplexed optical signals. Said plurality of inverse-multiplexed optical signals are transmitted from a source node to a destination node along a plurality of paths. A latency difference between a fastest one of said paths and a slowest one of said paths is less than a predetermined time period.

Said plurality of paths may be determined in accordance with the above routing method.

In a third aspect, the present invention provides a method for provisioning an optical network. The method comprises selecting a type of equipment for installation in a link of an optical network from a plurality of types of equipment. Each type of equipment has a respective latency. The equipment type is selected in dependence upon its latency. The equipment type is preferably selected such that a latency difference between a path comprises the link with the selected equipment installed, and a further path comprising at least one other link, is less than a predetermined time period.

The present inventor has appreciated that the concept of ensuring that the difference in latency between the paths is kept within a predetermined (acceptable) limit can be taken into consideration at the network provisioning stage. For example, in situations in which a variety of equipment types can be utilised to perform a similar function, the equipment type can be selected that acts to keep the difference in latency between particular paths through the network less than a predetermined time period. This method could be implemented by minimising the difference in latency between predetermined links and/or predetermined paths including those links.

The plurality of types of equipment may comprise dispersion compensating modules.

The plurality of types of equipment may comprise a length of optical fibre e.g. optical transmission fibre.

The method may further comprise performing the method for routing inverse-multiplexed optical signals over the network in accordance with any of the above methods.

The method may further comprise installing the selected equipment in the link.

In a fourth aspect, the present invention provides a data carrier carrying computer readable instructions for controlling a processor to carry out any of the above methods.

In a fifth aspect, the present invention provides a routing system comprising: a programme memory storing processor readable instructions; and a processor configured to read and execute instructions stored in said programme memory. Said processor readable instructions comprise instructions for controlling the processor to carry out any of the above methods.

In a sixth aspect, the present invention provides an apparatus for routing of optical signals through an optical network. The apparatus comprises a memory for storing data indicative of a set of possible paths from a source node to a destination node of an optical network. A processing unit is arranged to determine a plurality of paths from said set for transmission of a plurality of inverse-multiplexed optical signals from a source node to a destination node of an optical network, each path for transmission of at least one of said inverse-multiplexed optical signals, such that a latency difference between a fastest one of said paths and a slowest one of said paths is less than a predetermined time period.

In a seventh aspect, the present invention provides an optical network comprising an above apparatus or an above routing system.

In an eighth aspect, the present invention provides an optical network comprising: an inverse multiplexer for inverse multiplexing a data stream to a plurality of inverse multiplexed optical signals. At least one transmitter is arranged for transmitting said plurality of inverse-multiplexed optical signals from a source node to a destination node along a plurality of paths. A latency difference between a fastest one of said paths and a slowest one of said paths is less than a predetermined time period.

At least one of said paths may comprise a link from a first node to a second node and a link from said second node back to the first node.

### BRIEF DESCRIPTION OF THE DRAWINGS

Preferred embodiments of the present invention will now be described, by way of example only, with reference to the accompanying drawings, in which:

FIG. 1 is a schematic diagram of an optical mesh network illustrating a link, a subpath and a path through the network;

FIG. 2 is a flowchart of a method of routing and transmitting data over an optical network;

FIG. 3 is a schematic diagram of an optical network indicating the best quality path from the source node to the destination node;

FIG. 4 is a schematic diagram of an optical network including a single bottleneck, indicating two paths from the source node to the destination node determined in accordance with an embodiment of the present invention;

FIG. 5 is a schematic diagram of an optical network including two bottlenecks, indicating two paths from the source node to the destination node determined in accordance with an embodiment of the present invention;

FIG. 6 is a schematic diagram of an optical network including three bottlenecks, indicating paths from the source node to the destination node, including one split path determined in accordance with an embodiment of the present invention;

FIG. 7 is a schematic diagram of an optical network including a single bottleneck, indicating two paths from the source node to the destination node determined in accordance with an embodiment of the present invention, one of the paths comprising a link from a particular node to a further node, and a link back from that further node to the particular node; and

FIG. 8 is a flowchart of a method of provisioning an optical network.

### DETAILED DESCRIPTION

The present inventor has appreciated that it is the difference in path latency that is most significant, rather than the absolute latency of each path. By ensuring that the difference in latency is kept within a predetermined, (acceptable), limit, routing of inverse-multiplexed signals along diverse paths becomes feasible.

A preferred embodiment will now be described, in the form of a method for generating routes in an optical network from a source node to a destination node through different paths (if needed) where the differential latency time is minimized by means of properly choosing the paths themselves.

For each optical link, the total latency introduced by each component is recorded (i.e. fiber, DCM, amplifier latencies). The method determines the paths from source to destination that minimizes the differential latency time while satisfying the constraints of link capacity and any other constraints that may be imposed e.g. path transmission quality, path diversity, and path loading.

In this way a high-speed connection from source and destination can be realized via transmission of several lower-speed optical signals/connections while minimizing the requirement for expensive high-speed electronic buffering and processing.

The method can be applied to high-speed optical connections routed in any WDM network. The feasibility of given optical connections can be assessed by network design planning software. The status of installed fiber, network elements, active and available wavelengths is normally known by the network operator, but if not can be assessed by a network management system. The method is then applied for the determination of a set of low-speed optical circuits and node settings for which the data buffering required at both ends is minimized.

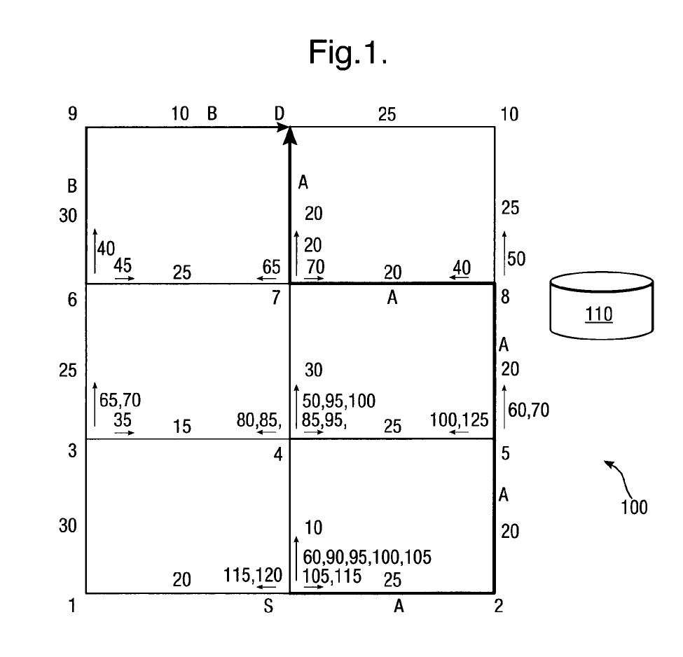

FIG. 1 shows an optical mesh network 100 in accordance with an embodiment of the invention. The network 100 comprises a plurality of switching nodes S, D and 1-10. Each switching node is shown as a vertex in the figures. Each switching node is connected to at least two adjacent switching nodes by links (illustrated in the figures by the lines extending between the nodes).

A switching node is an optical node that can reroute traffic. For example, a multi-degree reconfigurable optical add/drop multiplexer implemented with WSS (wavelength selective switch) technology can function as a switching node. In the figures, only the switching nodes and links between the switching nodes are illustrated, although it should be appreciated the network may comprises additional, non-switching nodes

A path is a circuit on the network from a source node S to a destination node D. A path is characterized by the routing and the signal type (i.e. bit-rate and modulation format). A set of low-speed traffic (e.g. optical signals) can be routed on the same path if there is enough capacity from end to end; otherwise, they must be routed through different paths, as described below. A path A from node S to node D via nodes 2,5,8,7 is shown in FIG. 1.

In this example, both the source node S and the destination node D are switching nodes.

The source node S comprises an inverse multiplexer for inverse multiplexing a data signal into a plurality of optical signals (inverse-multiplexed optical signals). Node S also comprises at least one transmitter for transmitting the optical signals.

The destination node D comprises a receiver for receiving the inverse multiplexed signals, and at least one buffer for storing the received signals for realignment e.g. to compensate for the difference in transmission. Each buffer may be an optical buffer or an electrical buffer. The buffer(s) will have a predetermined capacity, and it is this capacity that determines the acceptable latency difference e.g. the latency difference between the paths that should not be exceeded, as otherwise the latency difference between the inverse-multiplexed optical signals can not be compensated for.

The destination node also comprises a multiplexer, to multiplex together the received inverse-multiplexed signals to re-form the original data stream.

A subpath is a circuit on the network from a particular switching node to another switching node e.g. it can be a portion of a path. FIG. 1 shows a sub-path B from node 6 to node D via node 9.

A link is a circuit connecting two switching nodes that does not contain switching nodes. Subpaths and paths are concatenations of links. Links can contain any number of network elements like in-line amplification nodes that do not have switching properties. Each link in the figures is shown as a line, with an associated number part-way along (e.g. the link from node S to node 1 is shown with a 20). The associated number represents the latency of that link e.g. it is representative of the time it would take an optical signal to travel from between the nodes connected by that link.

The network 100 also comprises a routing apparatus or routing system 110 for routing of optical signals through the network in accordance with an embodiment of the present invention. The routing apparatus is configured to control the routing of the optical signals e.g. to control the switching of the switching nodes. The routing apparatus can be an apparatus located at a single physical location, or can be distributed across a number of locations.

The routing apparatus 110 can be implemented using any appropriate processor/processing element, including a dedicated circuit, a dedicated microprocessor, or a microprocessor which performs other functions. The processing element may be implemented using digital or analogue electronics or electrical circuits. The instructions for performing the relevant functional blocks of the routing method may be hard wired into the processing element, or may be provided as processor readable instructions stored in a programme memory or on a data carrier.

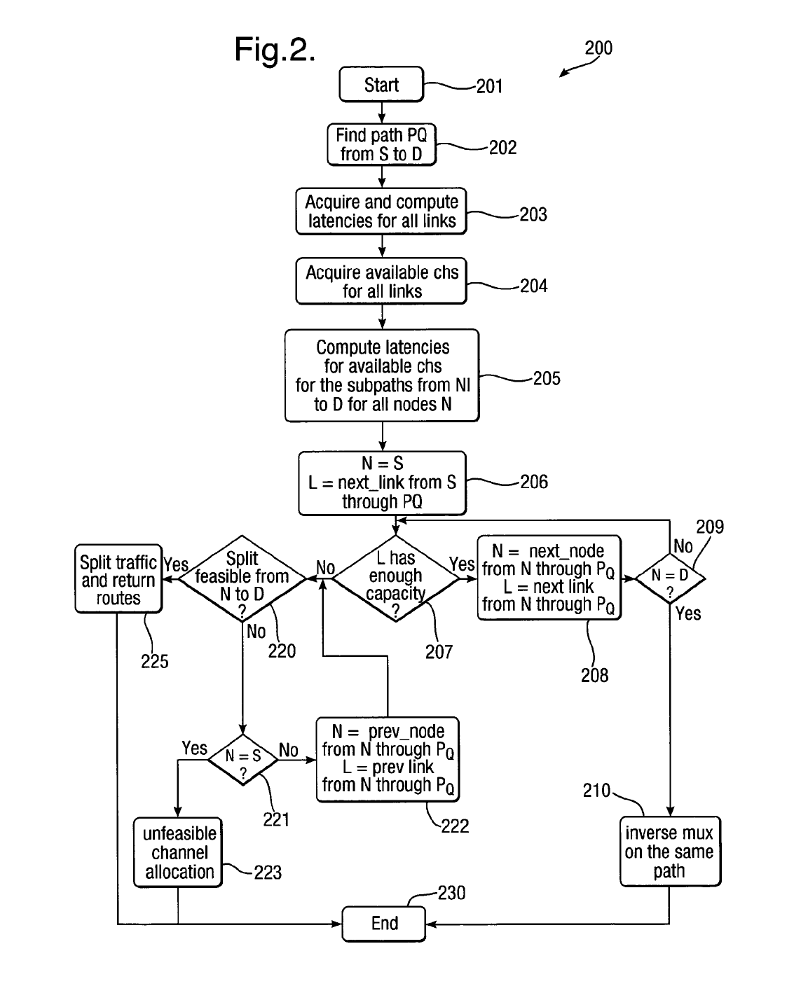

A method 200 of operation of the network 100 will now be described with reference to the flowchart shown in FIG. 2, which shows the main steps of determining paths though the network.

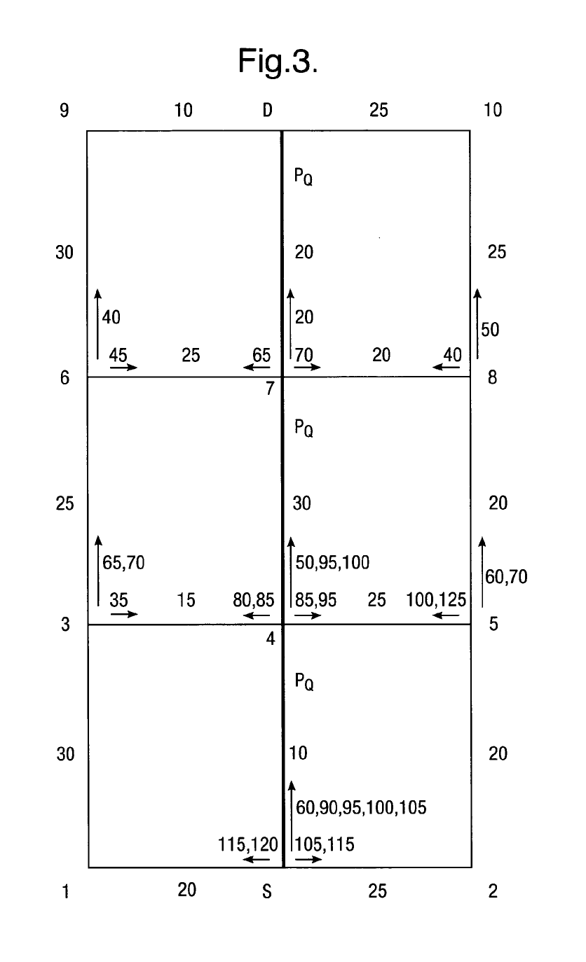

In this example, after the method has started (201), a calculation (202) is made of the highest-quality (highest-Q) path P_{Q} from source to destination. This is usually made by the network operator by means of network planning software or is made by the equipment vendor. P_{Q} is a privileged path because all other paths (in case it does not provide the required end-to-end bandwidth) can be thought of as a deviation from it. FIG. 3 shows the path P_{Q} through the network of FIG. 1, which in that example is the shortest path.

Data is acquired (203) relating to the latency of each link. Latencies are measured (or calculated) and stored for all components belonging to a link: e.g. transmission fibre spans, DCM, amplifiers and filters. Values are known from suppliers and can generally be assumed to be stable in time unless upgrade or maintenance interventions alter them (e.g. link rerouting or different DCM allocation or use of different dispersion compensation technology).

The availability of channels is determined for each link (204). For example, channel availability/loading for each link is typically available at network management level, and is kept up-to-date after each traffic upgrade/downgrade.

As indicated above, a key input parameter is the maximum tolerated differential latency Δt between the paths. That parameter is a characteristic parameter of the inverse inverse-multiplexing/multiplexing equipment (e.g. due to the capacity of the buffer(s)).

A calculation (205) is made of latencies and channel availability from each node Ni to the destination node D is made e.g. through standard graph search operations. This step can be optimized by back-propagating the information from a node M to another node N because (i) the channel availability is the intersection of the availability from M and the availability of the link L connecting M with N and (ii) the latency of subpath from N through M is the latency of the subpath from M plus the latency of the link L.

In the network figures, the different possible latencies for the various paths from each node are indicated adjacent the node, and adjacent to a small arrow indicating the initial link of that path. For example, in FIG. 1 a small arrow points along the link from node S towards node 1, with the two numbers 115,120 adjacent that arrow indicating that two paths are available including that link. The value of the numbers adjacent the arrows represent the latency of each sub-path from that node to the destination node D.

Starting (206) from node S, a check is made if the optimal path P_{Q} has enough channel availability, by iteratively considering whether each link L forming the path has sufficient capacity (207,208,209). If so, in this example, all inverse multiplexed channels are transmitted through it (210).

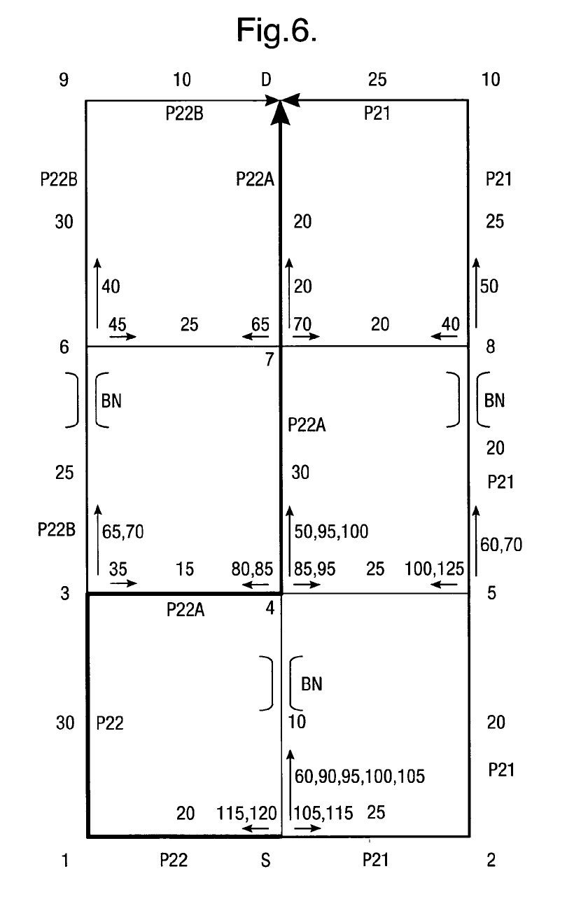

Otherwise, the method iteratively looks (220, 221, 222) for a node N along P_{Q} (including S) from which the channels can be “split” or routed through diverse paths, according to the channel availability of each path. The “split” is acceptable (225) if two conditions are verified: channel availability and maximum differential path latency are not greater than predetermined time period Δt. [The “split” step can also be applied in a nested way as described below with reference to FIG. 6, to overcome cascaded bottlenecks.]

If several path options are available, then other criteria may be used to determine the paths used to transmit the inverse-multiplexed signals.

For example, the paths with the lowest absolute latency may be selected (because they are correlated to lower distances, hence usually with higher signal quality). Alternatively the transmission quality of each possible path may be determined (e.g. calculated or measured), and the highest quality paths selected.

To minimise the load over the different links of the network, the loading by traffic of each link or path may be taken into account e.g. the lowest loaded paths selected.

In some instances, it may be preferable to maximise the path diversity e.g. to send each inverse-multiplexed signals over a completely separate path (i.e. paths without any links in common with any other paths), to minimise the impact of a link failure. For example, the determined paths may be selected from a set of possible paths in dependence upon a number of links that each possible path shares with other possible paths. In a completely separate path, each determined path would be comprised of different links.

The route calculation method stops successfully (210, 225) if a set of paths from S to D fulfilling the conditions of channel availability and maximum differential latency is found. If the method is successful, then the final step (230) includes controlling the network (e.g. the nodes) to set-up the determined transmission paths, with the inverse-multiplexed optical signals then being transmitted along the determined paths.

It terminates unsuccessfully (223) otherwise and another instance of it can be run with a higher (correlated to a more expensive buffering) Δt if only the predetermined time period was the limiting boundary.

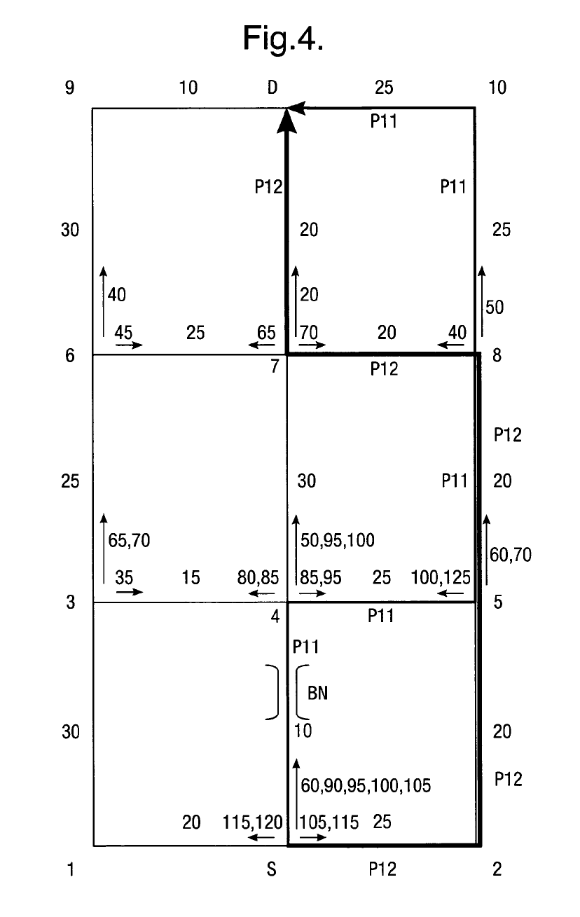

By way of further explanation, examples of paths calculated using the above method will be described with reference to FIGS. 4 to 8. In each case, the networks are the same as that shown in FIGS. 1 and 3, but with different available link transmission capacities.

### Example 1

### Single Bottleneck

In FIG. 4 it is supposed that the link capacity between S and 4 is not sufficient. The sign BN around the link between the nodes S and 4 represents the bottleneck. From node S, which is the node before the bottleneck, there are two different split possibilities, with latencies respectively 105 and 115. The two shortest paths have been chosen, and the links forming each path are indicated by reference numerals P11 and P12 respectively.

### Example 2

### Double Bottleneck

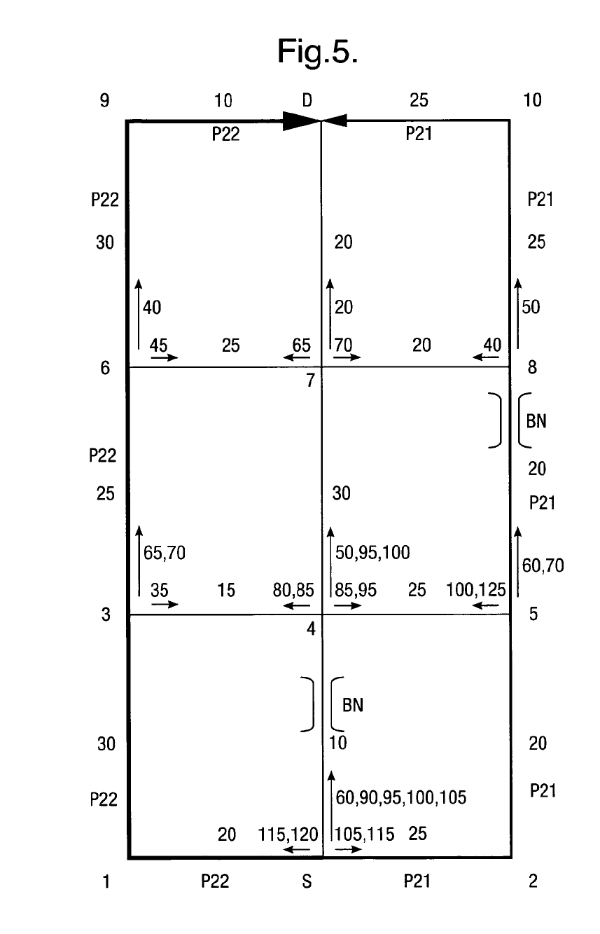

FIG. 5 is based on the previous example, but with an additional bottleneck BN in the link between nodes 5-8 where full capacity was required. Hence the two paths required to transmit the inverse multiplexed signal cannot both be routed through that link. Starting from S the other split possibility (latency 115) gives the solution. The links of the two paths are shown by P21 and P22. Note that in this case full path diversity has been obtained.

### Example 3

### Nested Split

FIG. 6 is based on the previous example, but with an additional bottleneck BN in the link between nodes 3-6. Channels going through the path P21 are not affected. However, there is not enough capacity for all channels of previous path P22 to pass through the link between nodes 3-6. The method looks for two subpaths (P22A & P22B) having the same latency from node 3 to the destination node D. The solution consists in a subset of channels going along subpath P2213 from node 3 through nodes 6 and 9 (whose latency is 25+30+10=65) and another subset being routed along subpath P22A through nodes 4 and 7 (latency is 15+30+20=65).

### Example 4

### Bouncing Paths

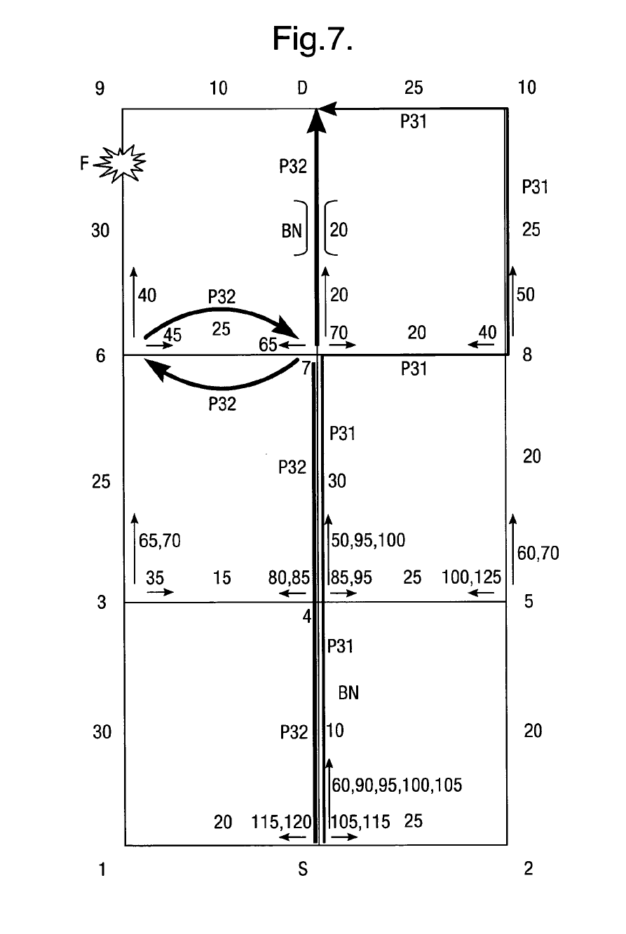

In the example shown in FIG. 7, the only bottleneck BN is in the link between nodes 7-D. This means that both paths of the inverse multiplexed signal cannot both be routed through it. Candidate subpaths with differential latency not greater than 5 are respectively through nodes 6 and 9 for one set of channels (for a total latency of 65) and through nodes 8 and 10 for the other set of inverse-multiplexed channels (total latency 70).

If it is assumed that the link between nodes 6-9 is unavailable (e.g. due to a fibre fault F): the minimum differential latency for subpaths from 7 to D is (70−20=50>>5), which is unacceptably high.

A novel proposed use of a link (or links) between two nodes can be utilized to address this problem, with the link(s) acting as an optical delay line, to increase path latency (for minimization of differential latency).

The destination node (node 6 in FIG. 7) from which the path “bounces” could comprise a multi-degree ROADM that can be implemented by means of Wavelength Selective Switch. One drop port of the node can be dedicated to re-routing the traffic coming from a link to the same link but in the opposite direction.

The path latency is increased by the time delay introduced by the same link being traversed in both directions (assuming the links are bidirectional). The impact on node flexibility is minimal because the node degree (i.e. number of manageable branches) is decreased only by one.

As can be seen in FIG. 7, this concept can be effectively employed to route one set of channels from node 7 to 6 and back to node 6 to 9. This “bouncing path” thus acts as an optical buffer, such that the differential latency of the paths becomes acceptable:

(25+25+20)−(20+25+25)˜0

The resulting paths are shown respectively as P31 and P32 (with P32 being the “bouncing path” i.e. the path includes a link from a first node to a second node and a link from said second node back to the first node).

### Network Provisioning

The concept of differential latency between paths through the network is also preferably taken into account during the provisioning of the network e.g. during the design of a new network or the design of upgrades to the network. Equipment can be selected, so as to minimise the differential latency between links on the network and/or paths through the network, so as to allow inverse-multiplexing and/or increase the possible paths available for inverse-multiplexing.

Each item of equipment will have a latency i.e. the time taken for the optical signal to be output from the equipment after the initial optical signal has been input to the equipment. If the equipment is all-optical, then this would normally be the time taken for the optical signal to be transmitted from the input port to the output port of the equipment.

In some situations, different types of equipment can perform the same function. For example, optical dispersion can be compensated for using a number of different optical technologies such as fibre-based dispersion compensation modules (which have a relatively high latency, which increases with the fibre length) or grating-based dispersion compensation modules (which have a relatively small latency).

The equipment types considered can include the transmission fibre e.g. with each type of equipment relating to a different length (or range of lengths) of transmission fibre. As the length of the transmission fibres may be varied, correspondingly the actual routes taken by the transmission fibres between nodes can be altered, so as to minimise the differential latency between particular links and/or paths through the network.

The minimisation of the differential latency can be considered on a number of levels. The differential latency between each link in the network could be minimised (or, at least kept within a predetermined time period, to allow inverse-multiplexing). Alternatively, depending on the network configuration and its intended use, particular links and/or paths including those links could be identified as being likely for use in inverse-multiplexing transmission, with the provisioning method applied to those links and/or paths to ensure that the differential latency between the particular links and/or paths is kept within a predetermined time period.

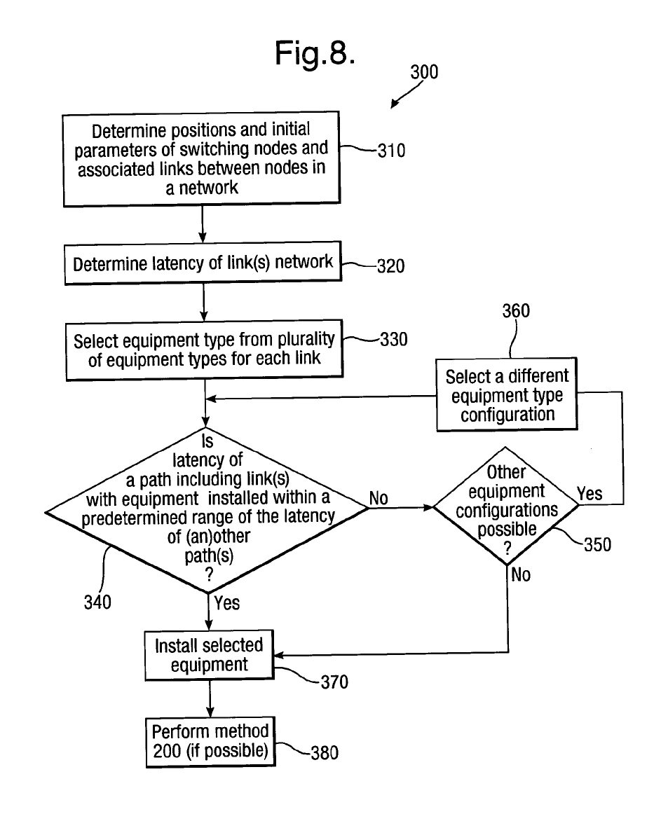

It will be appreciated from the forgoing that various techniques for implementing such a provisioning method could be utilised by the skilled person. By way of example only, FIG. 8 shows a flowchart of a relatively simplistic method for provisioning of a network 300.

In the method 300 shown in FIG. 8, the particular positions and initial parameters of the switching nodes and associated links between the nodes in the network are first determined (step 310). In this particular example, it is assumed that the links between the nodes are fixed by external factors e.g. via existing fibre connections, due to the method being an upgrade of an existing network from a low speed network to a high speed network that requires additional equipment (such as dispersion compensation equipment).

The latency of links in the network is determined (step 320). This step 320 can be carried out for a particular sub-set of links that have been identified as being particularly useful for inverse-multiplexing of channels, or it can be carried out for all links in the network.

Steps (330, 340, 350, 360) are then carried out to select a particular type of equipment from a plurality of types of equipment such that a latency difference between a path comprising said link with the selected equipment installed and a further path comprising at least one other link is less than a predetermined time period.

For example, the types of equipment could be dispersion mode compensation modules, with the network being upgraded to allow transmission of 100 G traffic. A typical fibre-based dispersion compensation module capable of compensating for 160 km of ITU-T G.652 fibre has a latency of around 110 micro seconds, whilst a grating-based module has a substantially shorter delay/latency (e.g. less than 0.1 micro seconds).

In this simplistic selection example, an initial selection of an equipment type (from the plurality of equipment types) is selected for each of the relevant links (e.g. for each link being updated that requires dispersion compensation) (step 330). A different type of equipment can be selected for each link.

A check (step 340) is then made to determine whether the differential latency of a path including the link(s) with the equipment installed would be in a predetermined range of the latency of one or more other predetermined paths i.e. whether the differential latency between the paths is within a predetermined time period.

If the differential latency is within a predetermined time period, then the equipment can be installed (step 370). Subsequently, the method of inverse-multiplexing (step 380) may then be performed, as the predetermined time period for the relevant differential latency is the same as that required for inverse-multiplexing.

If the differential latency of the paths is greater than the predetermined time period, then a check is made as to whether other equipment configurations are possible. If no other equipment configurations are possible, then the equipment may then be installed (step 370) anyway. In such instances, this may mean that the method of inverse-multiplexing of signals may not be performed, due to the equipment limitations (step 380).

If other equipment configurations are possible (step 350), then a different type of equipment configuration is selected (step 360) (i.e. a different type of equipment may be selected for one or more of each of the links), and then the step 340 perform once again.

As will be understood from the foregoing description, by ensuring that the difference in latency is kept within a predetermined, acceptable, limit, routing of inverse-multiplexed signals along diverse paths becomes feasible. Thus, more efficient use can be made of the available bandwidth between source and destination nodes, rather than all traffic having to be transmitted along the same route. For example, the technique allows inverse-multiplexed signals to be sent from a source to a destination along diverse paths, when a single path can not provide the necessary capacity (i.e. has a bottleneck link, a link with insufficient capacity to carry all inverse-multiplexed signals). Further, if a protection channel is transmitted, due to the different routes that may be taken by the inverse-multiplexed signals, any line fault need not affect all channels at the same time i.e. inverse-multiplexed signals need not be limited to card fault protection.

The method can extend the applicability of the inverse multiplexing technique in meshed optical networks by allowing for path diversity whilst earlier solutions are restricted to share the same path.

The route generation method can minimize the need for very costly high-speed electronic buffering at end nodes. The end-to-end connection resiliency is increased because, when required path diversity, the N:1 protection can counteract the sub-channel disruption.

The method can fall back to the optimal path (max signal quality) in case there are no constraints on wavelength allocation. The method does not require upgrading the physical optical network to carry the new services. The spare and, usually, sparse residual capacity of the network can be exploited with mainstream technology to provide new ultrahigh-bandwidth services.

1. A method for routing inverse-multiplexed optical signals over a network, the method comprising:
determining a plurality of paths for transmission of a plurality of inverse-multiplexed optical signals from a source node to a destination node of an optical network, each path for transmission of at least one of said inverse-multiplexed optical signals,
wherein a latency difference between a fastest one of said paths and a slowest one of said paths is less than a predetermined time period.

2. A method as claimed in claim 1, wherein said latency difference is less than a latency difference between said plurality of inverse-multiplexed optical signals that can be compensated for at the destination node.

3. A method as claimed in claim 1, wherein the determined paths are selected from a set of possible paths in dependence upon latency difference between the possible paths.

4. A method as claimed in claim 3, wherein the set comprises at least one path comprising a link from a first node to a second node and a link from said second node back to the first node.

5. A method as claimed in claim 1 wherein the determined paths are selected from a set of possible paths in dependence upon a transmission quality of each possible path.

6. A method as claimed in claim 1 wherein the determined paths are selected from a set of possible paths in dependence upon a loading of each possible path.

7. A method as claimed in claim 1, wherein the determined paths are selected from a set of possible paths in dependence upon a number of links that each possible path shares with other possible paths.

8. A method as claimed in claim 1, wherein each determined path comprise different links.

9. A method as claimed in claim 1, wherein the network is a mesh network.

10. A method as claimed in claim 1, wherein said inverse-multiplexed optical signals are derived from the inverse multiplexing of a single data stream.

11. (canceled)

12. A method as claimed in claim 1, comprising transmitting said inverse-multiplexed optical signals from said source node towards said destination node along the determined paths.

13. A method of transmitting optical signals over a network, the method comprising:
inverse multiplexing a data stream to a plurality of inverse multiplexed optical signals; and
transmitting said plurality of inverse-multiplexed optical signals from a source node to a destination node along a plurality of paths,
wherein a latency difference between a fastest one of said paths and a slowest one of said paths is less than a predetermined time period.

14. A method as claimed in claim 12, wherein said plurality of paths are determined in accordance with a method for routing inverse-multiplexed optical signals over a network, the method comprising:
determining a plurality of paths for transmission of a plurality of inverse-multiplexed optical signals from a source node to a destination node of an optical network, each path for transmission of at least one of said inverse-multiplexed optical signals,
wherein a latency difference between a fastest one of said paths and a slowest one of said paths is less than a predetermined time period.

15. A method for provisioning equipment in an optical network, the method comprising:
selecting a type of equipment for installation in a link of an optical network from a plurality of types of equipment, each type of equipment having a respective latency,
wherein the type of equipment is selected in dependence upon the latency of the equipment, such that a latency difference between a path comprising said link with the selected equipment installed and a further path comprising at least one other link is less than a predetermined time period.

16-18. (canceled)

19. A method as claimed in claim 14, comprising the step of installing the selected equipment in the link.

20. A data carrier carrying computer readable instructions for controlling a processor to carry a method for routing inverse-multiplexed optical signals over a network, the method comprising:
determining a plurality of paths for transmission of a plurality of inverse-multiplexed optical signals from a source node to a destination node of an optical network, each path for transmission of at least one of said inverse-multiplexed optical signals,
wherein a latency difference between a fastest one of said paths and a slowest one of said paths is less than a predetermined time period.

21. A routing system comprising:
a programme memory storing processor readable instructions; and
a processor configured to read and execute instructions stored in said programme memory,
wherein said processor readable instructions comprise instructions for controlling the processor to carry out a method for routing inverse-multiplexed optical signals over a network, the method comprising:
determining a plurality of paths for transmission of a plurality of inverse-multiplexed optical signals from a source node to a destination node of an optical network, each path for transmission of at least one of said inverse-multiplexed optical signals,
wherein a latency difference between a fastest one of said paths and a slowest one of said paths is less than a predetermined time period.

22. An apparatus for routing of optical signals through an optical network, the apparatus comprising:
a memory for storing data indicative of a set of possible paths from a source node to a destination node of an optical network; and
a processing unit arranged to determine a plurality of paths from said set for transmission of a plurality of inverse-multiplexed optical signals from a source node to a destination node of an optical network, each path for transmission of at least one of said inverse-multiplexed optical signals, such that a latency difference between a fastest one of said paths and a slowest one of said paths is less than a predetermined time period.

23. (canceled)

24. An optical network comprising:
an inverse multiplexer for inverse multiplexing a data stream to a plurality of inverse multiplexed optical signals; and
at least one transmitter for transmitting said plurality of inverse-multiplexed optical signals from a source node to a destination node along a plurality of paths,
wherein a latency difference between a fastest one of said paths and a slowest one of said paths is less than a predetermined time period.

25. An optical network as claimed in claim 19, wherein at least one of said paths comprises a link from a first node to a second node and a link from said second node back to the first node.
